(19) United States
(12) Patent Application Publication
(10) Pub. No.: US 2024/0118959 A1
(43) Pub. Date: Apr. 11, 2024

(54) RULE GENERATION APPARATUS, METHOD AND PROGRAM

(71) Applicant: NIPPON TELEGRAPH AND TELEPHONE CORPORATION

(72) Inventors: Haruhisa NOZUE, Musashino-shi, Tokyo (JP); Satoshi SUZUKI, Musashino-shi, Tokyo (JP); Shunsuke KANAI, Musashino-shi, Tokyo (JP); Kazuaki AKASHI, Musashino-shi, Tokyo (JP); Naomi MURATA, Musashino-shi, Tokyo (JP); Fumika ASAI, Musashino-shi, Tokyo (JP)

(73) Assignees: NIPPON TELEGRAPH AND TELEPHONE CORPORATION, Tokyo (JP); NIPPON TELEGRAPH AND TELEPHONE CORPORATION, Tokyo (JP)

(21) Appl. No.: 17/768,445

(22) PCT Filed: Oct. 25, 2019
(86) PCT No.: PCT/JP2019/042045

§ 371 Date: Apr. 12, 2022

(51) Int. Cl. G06F 11/07

(52) U.S. Cl. CPC G06F 11/0766

(57) ABSTRACT

A rule generation device according to an embodiment includes: a database in which, for each fault, fault factor information including a fault factor part and a fault factor, fault events that occur due to this fault, a rule ID associated with a rule including a condition part and a result part are registered in association with one another; an importance degree determination unit determining, when fault events of a new fault that is a newly occurred fault are registered with the database, degrees of importance of the fault events of the new fault based on at least one of values calculated through statistical processing or analytical processing for information other than the fault events or overall information about the fault events, which are registered with the database; and a rule generation unit generating a rule for the new fault based on the degrees of importance.

### TECHNICAL FIELD

Embodiments of this invention relate to a rule generation device, a method and a program.

### BACKGROUND ART

There is a technique about creation of an IF-THEN rule for determining, based on an event that occurs due to a certain fault (hereinafter referred to as a fault event) in a monitoring target device, a fault factor which is an occurrence factor of the fault.

For example, as disclosed in Patent Literature 1, there is a technique in which a unique fault event combination is extracted for each fault case in a manner that the fault event combination is not duplicated with that of another fault case registered with a fault example database, and a rule capable of determining a fault factor part is automatically created and corrected, with the fault event combination as a characteristic fault event.

### CITATION LIST

### Patent Literature

Patent Literature 1: Japanese Patent Laid-Open No. 2018-028778

### SUMMARY OF THE INVENTION

### Technical Problem

In the technique disclosed in the above Patent Literature 1, however, all fault events are uniformly treated at the time of creating a rule for determining a fault factor part. Therefore, there may be a case where, since it is not possible to extract an appropriate fault event combination grasping characteristics of a fault, an appropriate rule cannot be created. Further, even if degrees of importance of fault events that are generally added in a monitoring target device or a monitoring system are used for weighting, it is often not appropriate because there may be a case where a fault event with a low importance is actually strongly related to a fault factor.

This invention is intended to provide a technique to create an appropriate rule grasping characteristics of a fault to prevent wrong detection or overdetection of a fault.

### Means for Solving the Problem

In order to solve the above problem, a rule generation device according to an aspect of this invention includes: a database in which, for each fault, fault factor information including a fault factor part and a fault factor, fault events that occur due to this fault, a rule ID associated with a rule including a condition part and a result part are registered in association with one another; an importance degree determination unit determining, when fault events of a new fault that is a newly occurred fault are registered with the database, degrees of importance of the fault events of the new fault based on at least one of values calculated through statistical processing or analytical processing for information other than the fault events or overall information about the fault events, which are registered with the database; and a rule generation unit generating a rule for the new fault based on the degrees of importance.

### Effects of the Invention

According to one aspect of this invention, it is possible to provide a technique to create an appropriate rule grasping characteristics of a fault more by weighting each of fault events based on at least one of values calculated through statistical processing or analytical processing for information other than the fault events or overall information about the fault events and prevent wrong detection or overdetection of a fault.

### BRIEF DESCRIPTION OF DRAWINGS

FIG. 1 is a block diagram showing an example of a software configuration of an abnormal part estimation system including a pattern extraction and rule generation device as a rule generation device according to a first embodiment of this invention, and a rule engine.

FIG. 2 is a diagram showing an example of hardware configurations of the pattern extraction and rule generation device and the rule engine.

FIG. 3 is a flowchart showing an example of a processing operation of the pattern extraction and rule generation device.

FIG. 4 is a block diagram showing an example of a software configuration for explaining flows of processes among the pattern extraction and rule generation device, the rule engine, a monitoring target device and a maintenance person.

FIG. 5 is a diagram showing an example of classes in the blocks shown in FIG. 4.

FIG. 6A is a flowchart showing an example of processing operations in the blocks shown in FIG. 4.

FIG. 6A.

FIG. 6B.

FIG. 6B is a flowchart continued from

FIG. 6C is a flowchart continued from

FIG. 7 is a diagram explaining an example of an IF-THEN rule.

FIG. 8 is a diagram showing an example of a unique pattern extraction procedure according to a prior-art technique.

FIG. 9 is a diagram showing an example of a unique pattern extraction procedure according to the first embodiment.

FIG. 10A is a flowchart showing an example of processing operations in an abnormal part estimation system including a pattern extraction and rule generation device as a rule generation device according to a second embodiment of this invention, and the rule engine.

FIG. 10B is a flowchart continued from FIG. 10A.

FIG. 11 is a flowchart showing an example of processing operations in an abnormal part estimation system including a pattern extraction and rule generation device as a rule generation device according to a third embodiment of this invention, and the rule engine.

FIG. 12 is a diagram showing an example of a unique pattern extraction procedure according to the third embodiment.

FIG. 13 is a flowchart showing an example of processing operations in an abnormal part estimation system including a pattern extraction and rule generation device as a rule generation device according to a fourth embodiment of this invention, and the rule engine.

FIG. 14 is a diagram showing an example of a unique pattern extraction procedure according to the fourth embodiment.

### DESCRIPTION OF EMBODIMENTS

Embodiments related to this invention will be explained below with reference to drawings. In the embodiments below, parts that are given the same number are regarded as performing similar operations, and duplicated description will be omitted.

### First Embodiment

(Configuration Example)

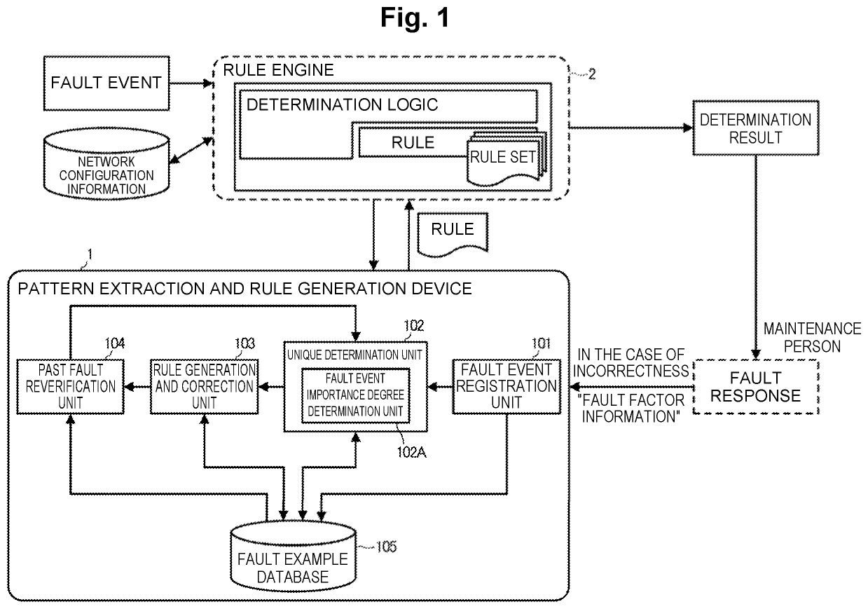

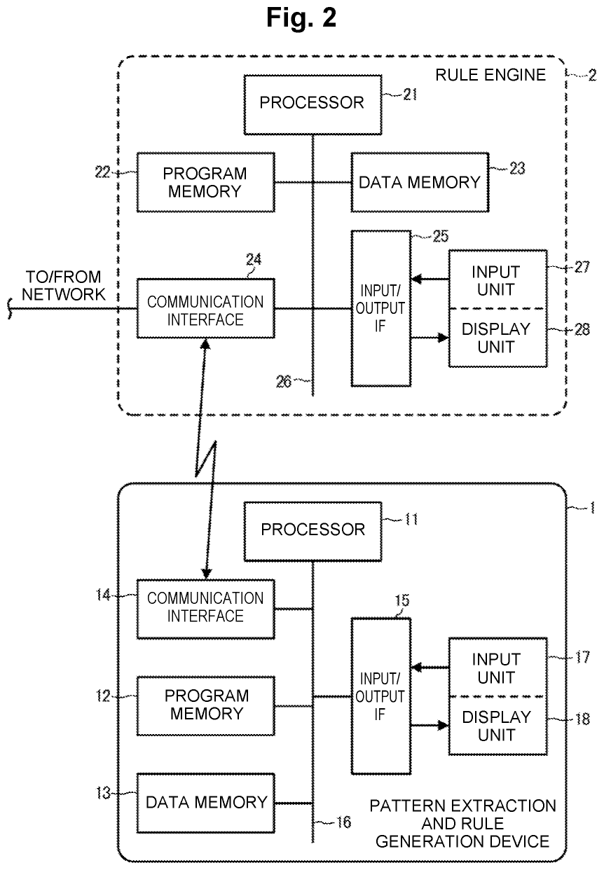

FIG. 1 is a block diagram showing an example of a software configuration of an abnormal part estimation system including a pattern extraction and rule generation device 1 as a rule generation device according to a first embodiment of this invention, and a rule engine 2. FIG. 2 is a diagram showing an example of hardware configurations of the pattern extraction and rule generation device 1 and the rule engine 2.

First, the hardware configurations will be explained.

As shown in FIG. 2, the pattern extraction and rule generation device 1 is configured, for example, with a server computer or a personal computer and includes a hardware processor 11 such as a CPU (central processing unit). In the pattern extraction and rule generation device 1, a program memory 12, a data memory 13, a communication interface 14, an input/output interface (in FIG. 2, written as an input/output IF) 15 are connected to the hardware processor 11 via a bus 16.

The communication interface 14 can include one or more wired or wireless communication modules. The communication interface 14 performs communication with the rule engine 2 to enable information exchange between the pattern extraction and rule generation device 1 and the rule engine 2.

An input unit 17 and a display unit 18 are connected to the input/output interface 15. As the input unit 17 and the display unit 18, what uses, for example, such a so-called tablet-type input/display device that an input detection sheet adopting an electrostatic method or a pressure method is arranged on a display screen of a display device using liquid crystal or organic EL (electroluminescence) is used. The input unit 17 and the display unit 18 may be configured with independent devices. The input/output interface 15 inputs operation information inputted on the above input unit 17 to the processor 11 and causes display information generated by the processor 11 to be displayed on the display unit 18.

Neither the input unit 17 nor the display unit 18 may be connected to the input/output interface 15. By being provided with a communication unit for connecting to the communication interface 24 directly or via a network, the input unit 17 and the display unit 18 are capable of performing giving and receiving of information with the processor 11.

The program memory 12 is, for example, such that a non-volatile memory to which and from which writing and reading is possible, such as an HDD (hard disk drive) or an SSD (solid state drive), and a non-volatile memory such as a ROM are combined and used, as a non-transitory and material computer-readable storage medium. In this program memory 12, a program required for the processor 11 to execute various kinds of control processes according to the first embodiment is stored.

The data memory 13 is, for example, such that the non-volatile memory described above and a volatile memory such as a RAM (random-access memory) are combined and used, as a material computer-readable storage medium. This data memory 13 is used so that various kinds of data acquired and created in a process of the various kinds of processes being performed are stored.

The rule engine 2 is provided, for example, in a management device or a maintenance terminal capable of communicating with devices such as routers and servers constituting a communication network (also referred to as nodes). As shown in FIG. 2, the rule engine 2 is configured, for example, with a server computer or a personal computer and includes a hardware processor 21 such as a CPU. In the rule engine 2, a program memory 22, a data memory 23, a communication interface 24, an input/output interface 25 are connected to this hardware processor 21 via a bus 26.

The communication interface 24 can include, for example, one or more wired or wireless communication modules. The communication interface 24 performs communication with the pattern extraction and rule generation device 1 to enable information exchange between the pattern extraction and rule generation device 1 and the rule engine 2. Further, the communication interface 24 is capable of communicating with a plurality of devices constituting the network and a network configuration information database (see FIG. 1) that stores connection information among these devices to acquire fault event information generated by each device and network configuration information stored in the network configuration information database.

An input unit 27 and a display unit 28 are connected to the input/output interface 25. As the input unit 27 and the display unit 28, what uses, for example, such a so-called tablet-type input/display device that an input detection sheet adopting an electrostatic method or a pressure method is arranged on a display screen of a display device using liquid crystal or organic EL (electroluminescence) is used. The input unit 27 and the display unit 28 may be configured with independent devices. The input/output interface 25 inputs operation information inputted on the above input unit 27 to the processor 21 and causes display information generated by the processor 21 to be displayed on the display unit 28.

Neither the input unit 27 nor the display unit 28 may be connected to the input/output interface 25. By being provided with a communication unit for connecting to the communication interface 24 directly or via the network, the input unit 27 and the display unit 28 are capable of performing giving and receiving of information with the processor 21. In this case, the input unit 27 and the display unit 28 may be caused to function as the input unit 17 and the display unit 18 of the pattern extraction and rule generation device 1. That is, one input unit and one display unit may be used as the input unit 17 and the display unit 18 of the pattern extraction and rule generation device 1 and the input unit 27 and the display unit 28 of the rule engine 2.

The program memory 22 is, for example, such that a non-volatile memory to which and from which writing and reading is possible, such as an HDD or an SSD, and a non-volatile memory such as a ROM are combined and used, as a non-transitory and material computer-readable storage medium. In this program memory 22, a program required for the processor 21 to execute various kinds of control processes according to the first embodiment is stored.

The data memory 23 is, for example, such that the non-volatile memory described above and the volatile memory such as a RAM described above are combined and used, as a material computer-readable storage medium. This data memory 23 is used so that various kinds of data acquired and created in a process of the various kinds of processes being performed are stored.

Next, the software configurations will be explained.

As shown in FIG. 1, the pattern extraction and rule generation device 1 can be configured as a data processing device provided with a fault event registration unit 101, a unique determination unit 102, a rule generation and correction unit 103, a past fault reverification unit 104 and a fault example database 105 as processing function units by software. The unique determination unit 102 is provided with a fault event importance degree determination unit 102A. Here, all of the processing functions in units of the fault event registration unit 101, the unique determination unit 102 including the fault event importance degree determination unit 102A, the rule generation and correction unit 103 and the past fault reverification unit 104 described above are realized by causing the program stored in the program memory 12 to be read out and executed by the hardware processor 11 described above. A part or all of these processing function units may be realized by other various forms including integrated circuits such as an ASIC (application-specific integrated circuit) and an FPGA (field-programmable gate array).

The fault example database 105 can be configured using the data memory 13 shown in FIG. 2. However, the fault example database 105 is not an essential component in the pattern extraction and rule generation device 1 but may be provided, for example, in an external storage medium such as an USB (universal serial bus) memory or a storage device such as a database server arranged in a cloud.

The fault event registration unit 101 registers one or more fault events (a fault event group) corresponding to a newly occurred fault (also referred to as a present fault or a new fault) with the fault example database 105 in association with (1) a fault ID of the present fault, (2) fault factor information showing a true cause and a position thereof identified by a maintenance person and (3) a corresponding rule ID.

The fault ID is given to each occurred fault. The rule ID is given to each rule.

A fault event is associated with a fault ID and shows an event that occurs due to a fault corresponding to the fault ID. The fault event is, for example, an alarm, log information or threshold monitoring information from a certain monitoring target device.

The fault factor information includes information about a fault factor part and information about a fault factor.

The fault factor indicates a cause of occurrence of the fault, and the fault factor part indicates a position (for example, a device ID) where the fault occurred. The fault factor part is the certain monitoring target device described above.

One or more fault events are also referred to as a fault event group. One or more rules are also referred to as a rule set.

The rule set is held, for example, by the rule engine 2, and each rule includes a condition part and a result part.

In the present first embodiment, the condition part is a fault event. The fault event can include, for example, a device ID and an alarm classification. Further, in the present first embodiment, the result part is fault factor information. The fault factor information can include, for example, a device ID and a fault factor classification.

The fault event importance degree determination unit 102A of the unique determination unit 102 determines degrees of importance of fault events. The determination is based on at least one of values calculated through statistical processing or analytical processing for information other than the fault events or overall information about the fault events, which is information required to calculate the degrees of importance of the fault events, the information being stored in the fault example database 105. In the present first embodiment, the degrees of importance of the fault events are determined based on occurrence situations of all the fault events, which are values calculated through analytical processing for the overall information about the fault events. An example of the importance degree determination method will be explained later.

The unique determination unit 102 generates fault event combinations each of which includes one or more fault events to be candidates for a unique pattern characterizing a present fault, from a fault event group of the present fault registered with the fault example database 105 and registers all the fault event combinations of the present fault with the fault example database 105. Accompanying the registration, the unique determination unit 102 refers to fault event combinations for all past faults registered with the fault example database 105. The unique determination unit 102 extracts, for each fault (that is, for each fault ID), a fault event combination characterizing each fault as a unique pattern from all the combinations referred to, taking account of degrees of importance of the fault events determined by the fault event importance degree determination unit 102A, and registers an extraction result with the fault example database 105 in association with the fault ID.

Fault event combinations exist for each fault ID and are combinations of all fault events associated with the fault ID.

A unique pattern is calculated for each fault ID from fault event combinations by a predetermined method, and one unique pattern is calculated for each fault ID. An example of the unique pattern calculation method will be explained later. A unique pattern corresponds to a rule ID one to one.

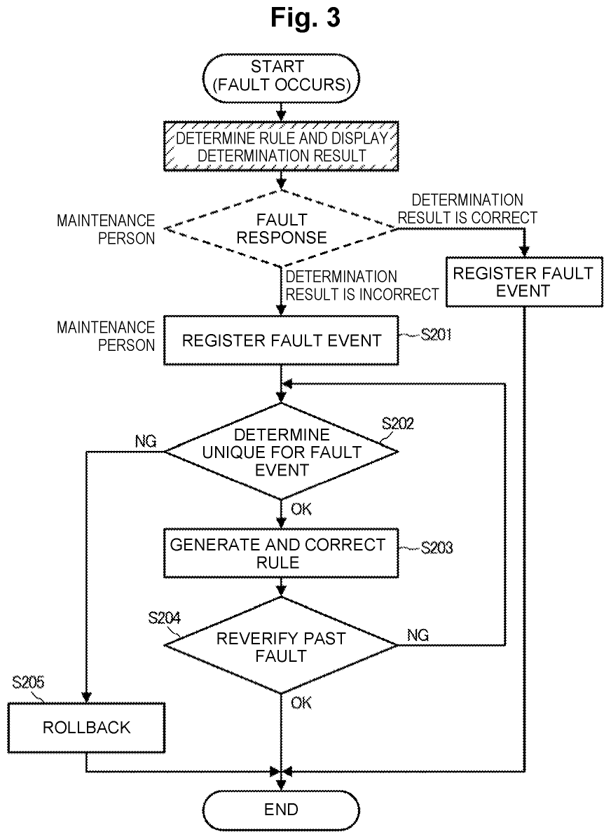

Further, there may be a case where one rule ID is registered, corresponding to a plurality of fault IDs so that a fault event is registered when a determination result is correct in fault response (see FIG. 3). Furthermore, since one rule ID corresponds to one or more fault events, there may be a case where one rule ID corresponds to many fault events. In the explanation below, fault events corresponding to certain one rule ID will be collectively referred to as “a fault case”. That is, a plurality of fault events corresponds to one “fault case”. Between “a fault case” and “a rule”, a one-to-one relationship holds.

For a present fault, the rule generation and correction unit 103 adopts a unique pattern extracted by the unique determination unit 102 as a condition part. Then, the rule generation and correction unit 103 adopts fault factor information registered by the maintenance person as a result part. The rule generation and correction unit 103 revises a rule set by newly generating a rule using these condition part and result part and registers a new rule ID with the fault example database 105 in association with a fault ID.

On the other hand, if a unique pattern extracted by the unique determination unit 102 corresponding to certain one fault in the past, which is registered with the fault example database 105, is different from a fault event combination defined for a condition part of a rule registered, corresponding to a fault ID of the fault, the rule generation and correction unit 103 determines that it is necessary to correct the rule. In this case, the rule generation and correction unit 103 adopts the extracted unique pattern as a condition part, overwrite-corrects the existing rule and registers a result of the correction with the fault example database 105.

For each fault ID, the past fault reverification unit 104 performs redetermination using the rule engine 2 based on information about a fault event group registered with the fault example database 105. The past fault reverification unit 104 compares fault factor information, which is a result of the determination, with fault factor information registered with the fault example database 105. The fault factor information was registered by the maintenance person in the past.

If a result of the comparison indicates correspondence, that is, if the comparison result is OK, the past fault reverification unit 104 determines that addition of the new rule is successful, furthermore determines that correction of the rule is also successful if the existing rule has been overwrite-corrected, and ends the process.

On the other hand, if the above result of the comparison does not indicate correspondence, that is, the comparison result is NG, the past fault reverification unit 104 causes the unique determination unit 102 to extract a different unique pattern again.

Though, in the redetermination by the past fault reverification unit 104, a comparison result is OK in almost all cases, there may be a rare case where the above comparison result is NG because of data modification or the like. The past fault reverification unit 104 is provided so as to respond even to such a case that the comparison result is NG.

In the fault example database 105, (1) a fault ID, (2) one or more fault events, (3) fault factor information, (4) fault event combinations, (5) a unique pattern among the combinations, and (6) a rule ID are registered in association with one another. In general, in the fault example database 105, the above pieces of information are stored in association with many fault IDs.

(Operation)

Next, an operation of the pattern extraction and rule generation device 1 will be explained. FIG. 3 is a flowchart showing an example of a processing operation of the pattern extraction and rule generation device 1 shown in FIG. 1.

When a fault occurs, the rule engine 2 acquires one or more fault events (for example, a device ID and an alarm classification) corresponding to the fault by the communication interface 24 and performs rule determination referring to network configuration information and a rule set. The rule engine 2 displays a rule determination result showing where the fault occurred and due to what cause the fault occurred, by the display unit 18.

After that, the maintenance person compares the displayed rule determination result by the rule engine 2 with a fault response result, which is a true cause, to determine whether the determination results are correct or not.

If it is determined that a determination result is correct, the pattern extraction and rule generation device 1 registers the fault event with the fault example database 105 in association with other pieces of information (see “the fault example database 105” described above) according to an operation against the input unit 17 by the maintenance person.

On the other hand, if it is determined that a determination result is not correct, the fault event registration unit 101 included in the pattern extraction and rule generation device 1 newly registers fault factor information showing a true cause and a position thereof identified by the maintenance person by fault response, with the fault example database 105 in association with other pieces of information, in a manner of corresponding to the fault event (step S201).

Next to step S201, the unique determination unit 102 generates all the fault event combinations each of which includes one or more fault events associated with the fault ID of the present fault as explained with reference to FIG. 1. Further, the fault event importance degree determination unit 102A of the unique determination unit 102 determines degrees of importance of the one or more fault events associated with the fault ID of the present fault, which have been registered at step S201, based on information registered with the fault example database 105. In the present first embodiment, the fault event importance degree determination unit 102A determines the degrees of importance of the one or more fault events described above, based on information about occurrence situations of all the fault events registered with the fault example database 105. For example, the fault event importance degree determination unit 102A can determine the degrees of importance of the one or more fault events described above based on occurrence frequencies of all fault events in the past. Then, the unique determination unit 102 extracts one unique pattern for each fault ID based on the fault event combinations corresponding to the present fault, fault event combinations corresponding to all the past faults (the fault event combinations for the past are already registered with the fault example database 105) and the determined degrees of importance described above (step S202). The extracted unique pattern is registered with the fault example database 105 in association with other pieces of information. On the other hand, if the unique pattern cannot be extracted, the process proceeds to step S205.

If a unique pattern is extracted at step S202, the rule generation and correction unit 103 adopts the unique pattern for the present fault as a condition part and adopts the fault factor information inputted by the maintenance person as a result part to newly generate a rule using the condition part and the result part. Then, the rule generation and correction unit 103 registers the generated rule with the fault example database 105. Further, the rule generation and correction unit 103 generates a rule ID corresponding to the generated rule and registers the rule ID with the fault example database 105 (step S203).

At step S203, there may be a case where a fault event combination defined for a condition part for a rule registered for a certain fault in the past, which is registered with the fault example database 105, is different from the unique pattern extracted at step S202 described above. In such a case, the rule generation and correction unit 103 corrects the rule for the fault and registers the corrected rule with the fault example database 105.

Next to step S203, the past fault reverification unit 104 redetermines whether a determination result is correct or not for each of all faults registered with the fault example database 105 using the rule engine 2, and verifies whether or not determination accuracy has decreased due to update of the rule set (step S204).

If a determination result is incorrect for any of the faults in the past, the process returns to step S202, and the unique determination unit 102 extracts another fault event combination. If, for all the rules generated from unique patterns, comparison results by the past fault reverification unit 104 are NG, the process proceeds to step S205.

On the other hand, if comparison results are OK as a result of verification by the past fault reverification unit 104 and determination results are correct, the process is ended on the assumption that addition of a new rule or correction of the rule is successful.

At step S205, when a fault event characterizing the present fault cannot be extracted, the unique determination unit 102 makes a presentation to the effect that the fault is a fault that cannot be ruled, to the maintenance person by the display unit 18, and rolls back data. That is, in this case, the unique determination unit 102 cancels registration of fault events corresponding to a corresponding fault ID of the present fault and the fault factor information registered by the maintenance person.

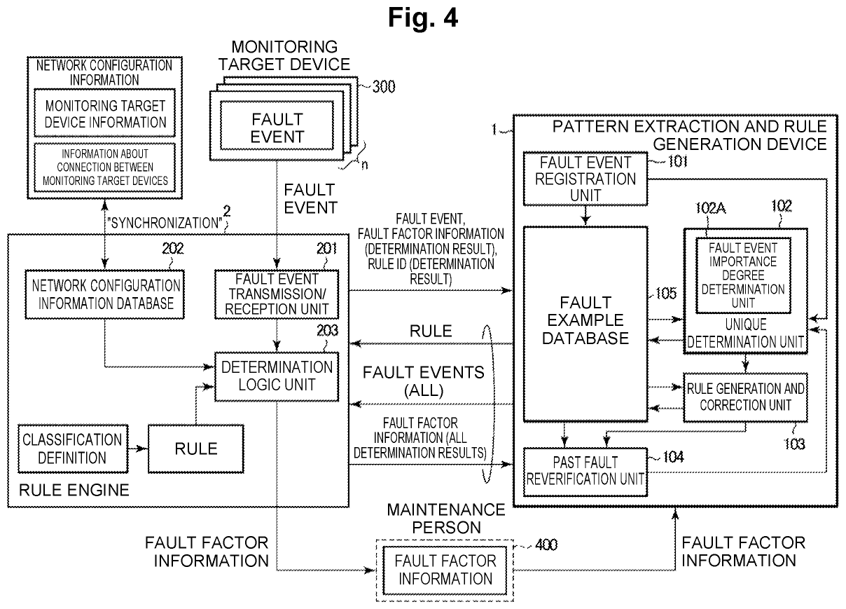

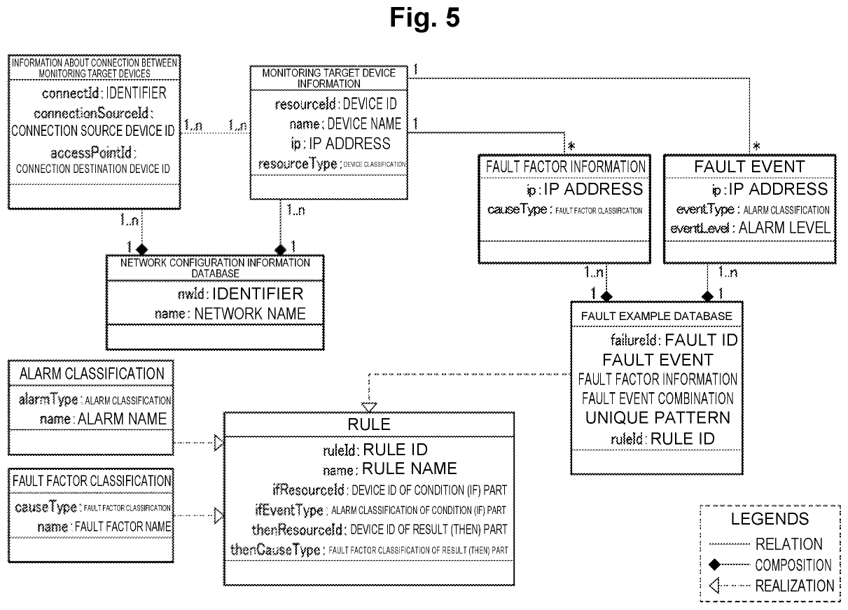

Next, flows of processes among the pattern extraction and rule generation device 1, the rule engine 2, a monitoring target device 300 and a maintenance person 400 of the present first embodiment will be described with reference to FIGS. 4, 5, 6A, 6B and 6C. Here, “*” shown in FIG. 5 indicates the number of instances and means a numerical value equal to or larger than zero.

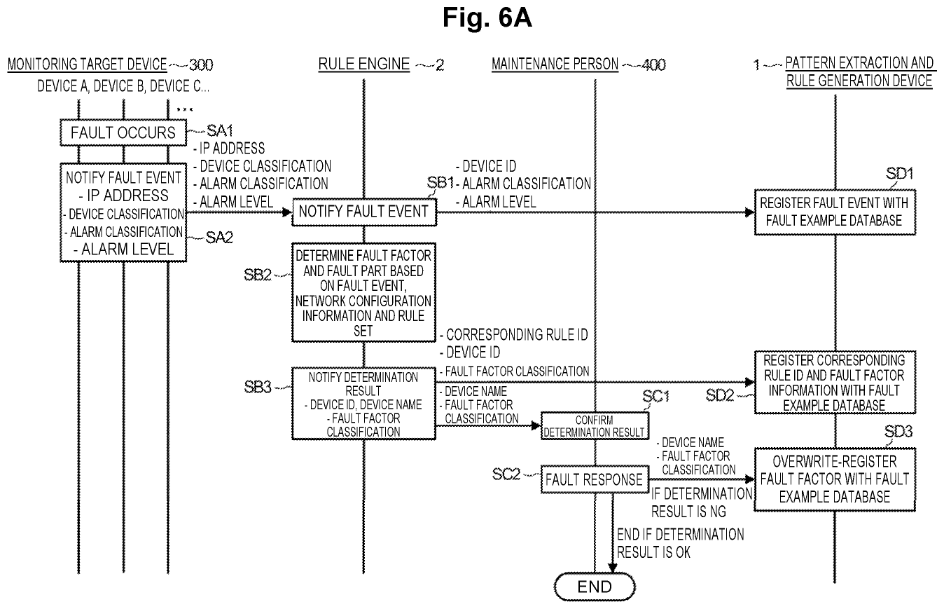

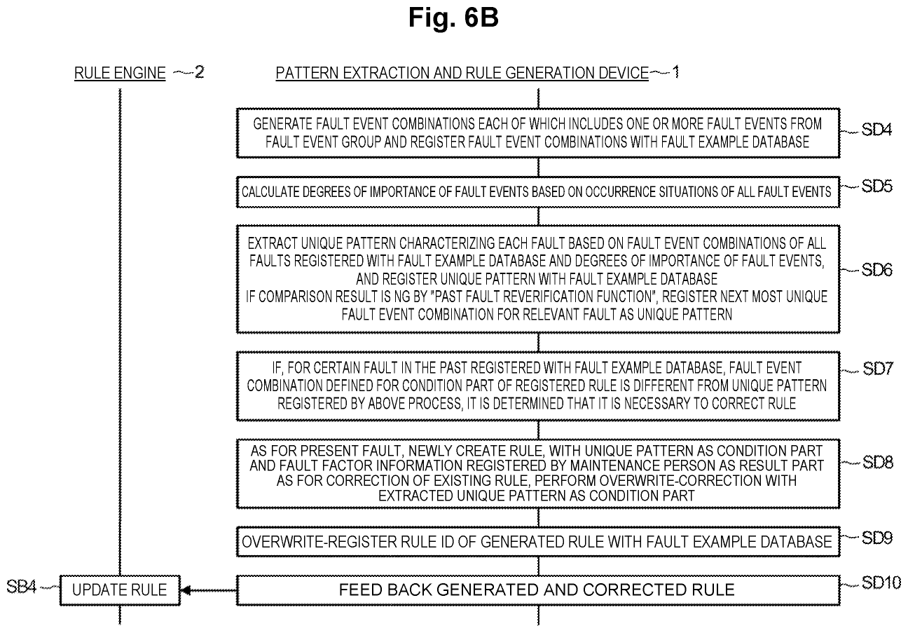

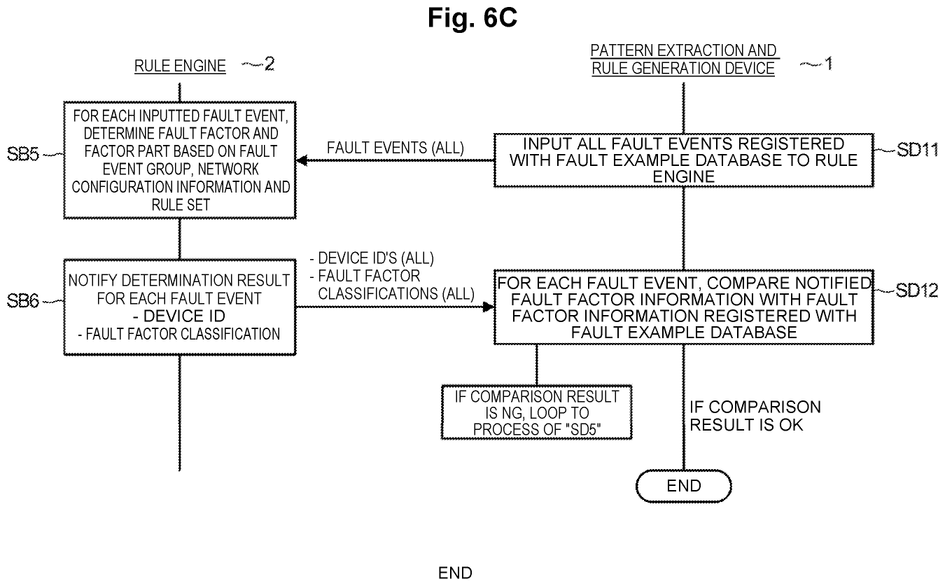

First, it is assumed that faults occur in one or more devices among n monitoring target devices 300 (step SA1 of FIG. 6A). After that, the monitoring target devices 300 notify the rule engine 2 of fault events (step SA2). Each fault event here includes, for example, (1) an IP address, (2) a device classification, (3) an alarm classification and (4) an alarm level. Here, the alarm classification is a kind of event classification and is used as a concept subordinate to the event classification. The alarm level is a kind of event level and is used as a concept subordinate to the event level. The event level indicates a degree of importance of the fault event added by the monitoring target device 300 or a monitoring system. There may be a case where the fault event does not include the alarm level.

A fault event transmission/reception unit 201 included in the rule engine 2 acquires the fault events notified from the external monitoring target devices 300 and notifies the pattern extraction and rule generation device 1 of the fault events (step SB1). At this stage, the fault event transmission/reception unit 201 notifies the pattern extraction and rule generation device 1, for example, of a device ID, an alarm classification and an alarm level as a fault event. The fault event registration unit 101 that receives the notification of the fault events registers the fault events with the fault example database 105 (step SD1).

Further, a network configuration information database 202 included in the rule engine 2 has acquired network configuration information from the outside and caused the network configuration information to be synchronized with external information. The network configuration information includes pieces of monitoring target device information and pieces of information about connection between monitoring target devices. Each piece of monitoring target device information includes, for example, (1) a device ID, (2) a device name, (3) an IP address and (4) a device classification of a monitoring target device as shown in FIG. 5. Each piece of information about connection between monitoring target devices includes, for example, (1) a connection source device ID, (2) connection destination device ID and (3) an identifier of a combination consisting of (1) and (2). In the examples shown in FIGS. 4 and 5, n pieces of monitoring target device information corresponding to the number of monitoring target devices are provided. The number of pieces of information about connection between monitoring target devices is not limited to n.

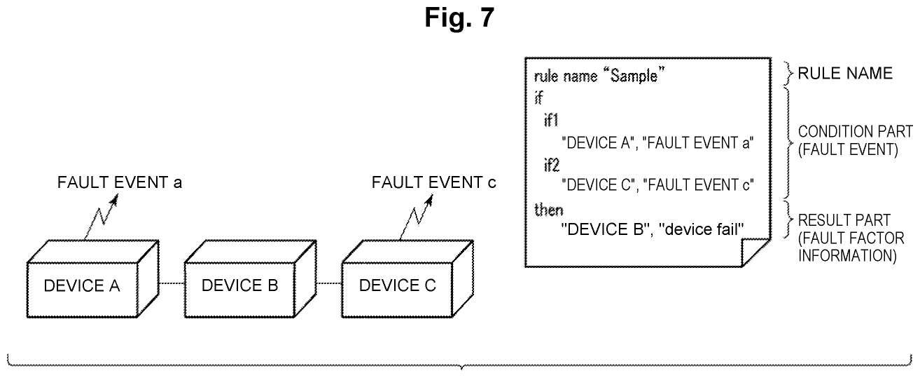

In the rule engine 2, a set of IF-THEN rules each of which associates a fault event group with fault factor information is stored, for example, in the data memory 23. Each IF-THEN rule is configured with an “if” part indicating an assumption or a condition and a “then” part showing a result or an operation when the “if” part is true (see explanation of FIG. 7 for more details).

Furthermore, the rule engine 2 includes a determination logic unit 203. The determination logic unit 203 receives each of the network configuration information (in the network configuration information database 202), the fault events and the rule set and, based on these, obtains determination results each of which shows where the fault occurred (a fault part) and due to what cause the fault occurred (a fault factor) (step SB2). After that, the determination logic unit 203 sends determination results, for example, (1) corresponding rule IDs, (2) device IDs and/or device names and (3) fault factor classifications to the pattern extraction and rule generation device 1 and sends determination results, for example, (1) the device names and (2) the fault factor classifications to the maintenance person 400 (step SB3). To send the determination results to the maintenance person 400 means to present the determination results to the maintenance person 400 by the display unit 28.

The fault event registration unit 101 included in the pattern extraction and rule generation device 1 registers the determination results from the determination logic unit 203, for example, (1) the corresponding rule IDs, (2) the device IDs and/or the device names and (3) the fault factor classifications with the fault example database 105 (step SD2).

The maintenance person 400 receives the determination results from the rule engine 2 by the display unit 28 and confirms content (step SC1). After that, the maintenance person 400 compares the determination results by the rule engine 2 with a fault response result, which are a true cause, to determine whether the above determination results are correct or not (step SC2).

If it is determined that the determination results are correct at step SC2, the process ends without the maintenance person 400 doing anything.

On the other hand, if it is determined that a determination result is not correct at step SC2, the pattern extraction and rule generation device 1 is notified of fault factor information that is information in which a true cause (a device name) and a position thereof are identified by fault response by the maintenance person 400, from the maintenance person 400. That is, the maintenance person 400 operates the input unit 17 to input the fault factor information. In the pattern extraction and rule generation device 1, the fault event registration unit 101 registers the fault factor information by the maintenance person 400 with the fault example database 105 in correspondence with the fault event (step SD3).

After that, the process of the pattern extraction and rule generation device 1 continues. That is, the unique determination unit 102 generates all fault event combinations each of which includes one or more fault events, from a fault event group of each of the present faults, and registers a generation result with the fault example database 105 (step SD4 of FIG. 6B).

Further, the fault event importance degree determination unit 102A included in the unique determination unit 102 determines degrees of importance of the one or more fault events, based on the information about the occurrence situations of all the fault events registered with the fault example database 105 (step SD5). For example, occurrence frequencies of all fault events registered with the fault example database 105 can be used as the occurrence situations of all the fault events. Of course, the occurrence situations of all the fault events are not limited to the above. A degree of importance of a fault event is a value obtained by quantifying how often the same fault event occurs, based on an occurrence frequency among all fault events. As a method for calculating the degree of importance of the fault event, a technique such as tf-idf (term frequency-inverse document frequency) can be used. The number of occurrences of fault events including fault events other than fault events of a relevant fault case is determined, and the degree of importance is defined to be lower when the number of occurrences is large but to be higher when the number of occurrences is large within the relevant fault case.

Hereinafter, an explanation will be made on an example of a calculation method for determining degrees of importance of fault events by occurrence frequencies of all fault events which are occurrence situations of all the fault event. Of course, the calculation method is not limited to the calculation method.

A fault event is defined as follows:
A set L of all fault events={l₁, l₂, . . . , lₘ};
A set C of all fault cases={c₁, c₂, . . . , cₙ}; and
A set E of all event classifications (alarm classifications)={e₁, e₂, . . . , eₘ}.

Here, each fault case c includes some examples, and each example includes some fault events 1. Further, the set E of all event classifications (alarm classifications) is regarded as a subset of L each of which is exclusive.

It is assumed that the number of times a certain event classification e appears in an example in a certain fault case c is written as F_{tf}. Here, F_{tf} can be regarded as mapping to cause a natural number (an integer equal to or larger than 0) to correspond to each of pairs of elements of E and elements of C.

F_{tf}:E×C→N

A degree of importance by the frequency of the event classification e in the fault case c is defined as a product of a value of S_{tf}(e,c) shown by Expression (1) below and a value of S_{idf}(e) shown by Expression (2) below. Here, S_{tf}(e,c) is an indicator of how often the event classification e occurs in the fault case c. An event classification that occurs more frequently in the same fault case is regarded as more important. Further, S_{idf}(e) is an indicator of how often the event classification e occurs among all the fault events. An event classification that occurs more frequently among all the fault events is regarded as less important.

$$[ Math . 1 ]$$

$${S}_{tf} ( e , c ) = \frac{{F}_{tf} ( e , c )}{{\sum }_{{e}^{′} ∈ E} {F}_{tf} ( {e}^{′} , c )} \qquad ( 1 )$$

$${S}_{idf} ( e ) = log \frac{‖ L ‖}{‖ e ‖} + 1 \qquad ( 2 )$$

The above is different from general tf-idf in the following points. That is, an event classification (an alarm classification) is assumed to be a “word” in tf, and a fault case is assumed to be a “document” in tf. Further, “whether a word is to be included or not” in general idf is caused to correspond to an event classification, and an individual fault event is regarded as a “document”.

Thus, with reference to the so-called idea of tf-idf, occurrence frequencies are counted not only for fault events adopted for rules but also for fault events not adopted for rules. Then, by causing a degree of importance of a fault event that frequently occurs in situations that are not in connection with a fault to be low (an idea of idf), and, on the contrary, causing a degree of importance of a fault event that occurs many times in connection with a certain fault to be high (an idea of tf), “a degree of rareness” of a fault event related to a certain fault is relatively calculated when attention is paid to the certain fault, and the degree of rareness is reflected on a degree of importance of the fault event.

The unique determination unit 102 extracts a unique pattern characterizing each fault from fault event combinations of all the faults registered with the fault example database 105, with reference to the degrees of importance of the fault events determined by the fault event importance degree determination unit 102A. Then, the unique determination unit 102 registers an extraction result with the fault example database 105 (step SD6). When the past fault reverification unit 104 reverifies a determination result for each fault, and a comparison result is NG as described later, the unique determination unit 102 registers the next most unique fault event combination for the fault with the fault example database 105 as a unique pattern.

The rule generation and correction unit 103 compares a fault event combination defined for a condition part of a rule registered for a certain fault in the past registered with the fault example database 105 with the unique pattern registered through the process performed so far. If both that are compared are different from each other, the rule generation and correction unit 103 determines that it is necessary to correct the rule (step SD7). For the present fault, the rule generation and correction unit 103 adopts the unique pattern as a condition part, adopts the fault factor information registered by the maintenance person 400 as a result part, and newly generates a rule using these condition part and result part. As correction of the existing rule, the rule generation and correction unit 103 overwrite-corrects the existing rule with the extracted unique pattern as a condition part (step SD8). After that, the rule generation and correction unit 103 overwrite-registers a rule ID of the generated rule with the fault example database 105 (step SD9).

Further, the rule generation and correction unit 103 feeds back the generated and corrected rule to the rule engine 2 (step SD10). The rule engine 2 takes in the generated and corrected rule to update the rule set (step SB4).

The pattern extraction and rule generation device 1 hands over all the fault events registered with the fault example database 105 to the rule engine 2, all the fault events being separated by fault IDs (step SD11 of FIG. 6C). The rule engine 2 receives all the fault events and determines, based on a fault event group, network configuration information and a rule set inputted for each fault ID, each of a fault factor and a fault factor part (step SB5). Then, the rule engine 2 notifies the pattern extraction and rule generation device 1 of a determination result for each fault ID, for example, a device ID and a fault factor classification (step SB6).

For each fault ID, the past fault reverification unit 104 included in the pattern extraction and rule generation device 1 compares the determination result notified from the rule engine 2, for example, the device ID and the fault factor classification with fault factor information registered with the fault example database 105 (step SD12). If there is a fault ID for which the comparison result is NG, the process returns to step SD4, and the unique determination unit 102 extracts a unique pattern and performs generation of a rule or correction. On the other hand, if the comparison result is OK for all the fault events, the process by the pattern extraction and rule generation device 1 ends.

Here, the IF-THEN rules used by the rule engine 2 will be simply explained with reference to FIG. 7.

The IF-THEN rules describe inferential knowledge such as a result derived from a certain fact and knowledge about behavior performed when a certain condition is met. In general, an IF-THEN rule is written in a form of “α→β” or “if α then β” and, as described above, is configured with an “if” part indicating an assumption or a condition and a “then” part indicating a result or behavior executed when the “if” part is true.

An example shown in FIG. 7 is a rule for determining a fault factor part, and a diagram on the left side and a diagram on the right side show a fault example and an IF-THEN rule, respectively. In this example, the IF-THEN rule shows that, if a fault event “a” occurs in a device A, and a fault event c occurs in a device C, a device B shows “device fail”. The “device A”, “device B” and “device C” in the IF-THEN rule are pieces of information uniquely identifying devices, such as IP addresses.

Next, an explanation will be made on the determination of degrees of importance of one or more fault events based on the information about the occurrence situations of all the fault events at step SD5 described above, and the process of extracting a unique fault event for each fault at step SD6 described above, by giving specific examples.

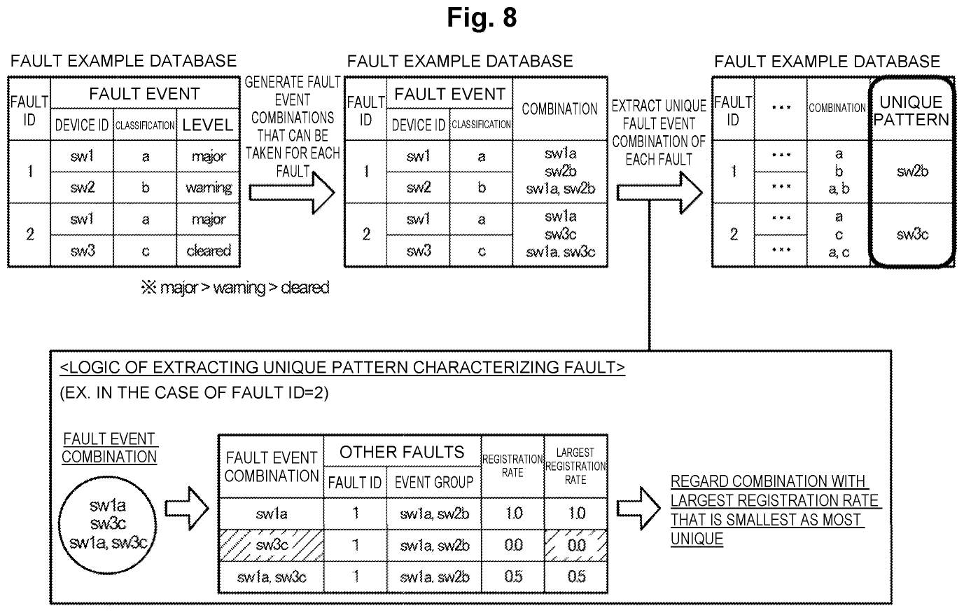

Here, in the fault example database 105, fault events have been associated and registered for each fault ID by the processes of steps SD2 and SD3 as shown in the upper left diagram in FIG. 8. In the example here, each fault event includes a device ID, an event classification (an alarm classification) and an event level (an alarm level). The event level indicates a degree of importance added by the monitoring target device 300 or the monitoring system. In this example, there are three classifications of event levels of “major”, “warning” and “cleared”, and degrees of importance is in order of major>warning>cleared. First, the unique determination unit 102 generates fault event combinations that can be taken for each fault and registers the combinations with the fault example database 105 at step SD4. In this example, for a fault ID=1, (device ID, event classification, event level)=(sw1, a, major), (sw2, b, warning) are shown; the number of all combinations is three as shown in the diagram at the upper middle in FIG. 8, that is, only (sw1, a) (“sw1a” in the diagram), only (sw2, b) (“sw2b” in the diagram) and (sw1, a) and (sw2, b) (“sw1a, sw2b” in the diagram). For a fault ID=2, (device ID, event classification, event level)=(sw1, a, major), (sw3, c, cleared) are shown; the number of all combinations is three, that is, sw1a, sw3c, and sw1a and sw3c. The unique determination unit 102 does not take account of the event levels included in the fault events.

Though, after that, the determination of degrees of importance of one or more fault events based on the information about the occurrence situations of all the fault events is performed at step SD5, such an extraction procedure by a prior-art technique as disclosed in Patent Literature 1 will be explained first with reference to FIG. 8 for comparison. Conventionally, a unique pattern is extracted without performing the operation of step SD5 described above. That is, conventionally, the unique determination unit 102 extracts a unique pattern from fault event combinations according to a unique pattern extraction logic at step SD6. The unique pattern extraction logic calculates, for each fault event combination, a registration rate for each of all the other fault IDs first and, after that, determines, for each fault event combination, the largest registration rate among the registration rates (there are a plurality of registration rates when there are a plurality of other fault IDs). Next, the unique pattern extraction logic sorts largest registration rates of all the fault event combinations and extracts a combination corresponding to the smallest value among these as a unique pattern.

Here, the registration rate is calculated with the number of events of a fault event combination as a denominator and the number of events of the fault event combination registered with another fault event group as a numerator. According to this, the registration rate takes a value from 0 to 1 and indicates to what degree one fault event combination for a certain fault ID is registered with a certain other fault ID. For example, if the registration rate is 1, it indicates that the one fault event combination for a noticed fault ID is registered with a fault event group for a certain other fault ID. If the registration rate is 0.5, it indicates that half of the one fault event combination for the noticed fault ID is registered for the certain other fault ID. Furthermore, if the registration rate is 0, it indicates that the one fault event combination for the noticed fault ID is not registered for the certain other fault ID at all. Further, a unique pattern can be said to be a combination that occurs least frequently among fault event combinations for the certain other fault ID, among fault event combinations for the noticed fault ID. That is, in other words, a unique pattern can be said to be a combination that least corresponds to a combination for the other fault ID, that is, a unique combination.

Next, the extraction of a unique pattern will be explained with reference to a specific example at a lower part of FIG. 8.

In the example of FIG. 8, the fault event combinations for a fault ID=2 are the three combinations of sw1a, sw3c, and sw1a and sw3c as described above. Further, since there are only two fault IDs, 1 and 2 in this example, it is only ID=1 that is a fault other than ID=2.

In the case of sw1a, the event group for the other fault ID=1 includes sw1a and sw2b. Therefore, since the number of fault events is only sw1a, the denominator is 1; and, since sw1a is registered with the event group for the other fault ID=1, the numerator is 1. Thus, the registration rate is 1/1=1.0.

In the case of sw3c, the event group for the other fault ID=1 includes sw1a and sw2b. Therefore, since the number of fault events is only sw3c, the denominator is 1; and, since sw3c is not registered with the event group for the other fault ID=1, the numerator is 0. Thus, the registration rate is 0/1=0.0.

In the case of sw1a and sw3c, the event group for the other fault ID=1 includes sw1a and sw2b. Therefore, since the number of fault events is sw1a and sw3c, the denominator is 2; and, since only one of sw1a and sw3c is registered with the event group for the other fault ID=1, the numerator is 1. Thus, the registration rate is 1/2=0.5.

From the above, the largest registration rate that is the smallest is 0.0, and a combination corresponding thereto is sw3c. Thus, the unique pattern for the fault ID=2 in the example of FIG. 8 is sw3c.

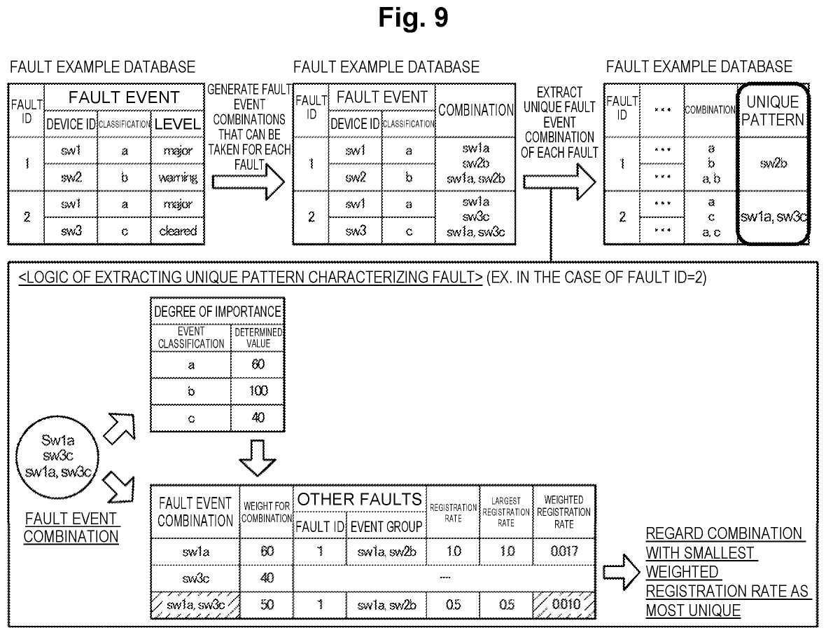

In comparison, in the present first embodiment, a unique pattern extraction procedure as shown in FIG. 9 is adopted. That is, in the present first embodiment, at the step SD5 described above, the fault event importance degree determination unit 102A of the unique determination unit 102 determines degrees of importance of one or more fault events based on the information about the occurrence situations of all the fault events registered with the fault example database 105. For example, for each event classification, the fault event importance degree determination unit 102A calculates a degree of importance as a value obtained by quantifying how often the same fault event occurred, based on an occurrence frequency among all fault events in the past.

After that, at step SD6, the unique determination unit 102 extracts a unique pattern according to a unique pattern extraction logic according to the present first embodiment, from the fault event combinations, based on the degrees of importance of the fault events. According to the unique pattern extraction logic, the unique determination unit 102 calculates, for each fault event combination, a combination weight based on the degrees of importance of the fault events first. After that, the unique determination unit 102 calculates, for each fault event combination, a registration rate for each of all the other fault IDs and determines, for each fault event combination, the largest registration rate among the registration rates (there are a plurality of registration rates when there are a plurality of other fault IDs). Next, the unique determination unit 102 weights the determined largest registration rate by the combination weight to calculate a weighted registration rate. Then, the unique determination unit 102 sorts weighted largest registration rates of all the fault event combinations and extracts a combination corresponding to the smallest value among these as a unique pattern.

Next, the extraction of a unique pattern will be explained with reference to a specific example at a lower part of FIG. 9.

In the specific example at the lower part of FIG. 9, fault event combinations for a fault ID=2 are three combinations of sw1a, sw3c, and sw1a and sw3c similarly to the example of FIG. 8. Further, since there are only two fault IDs, 1 and 2 in this example, it is only ID=1 that is a fault other than ID=2. As for degrees of importance for each event classification, it is assumed that 60, 100 and 40 have been determined for an event classification=a, an event classification=b and an event classification=c, respectively, in this example. Therefore, in this example, a combination weight in the case of the fault event combination sw1a is 60, which is the degree of importance of the event classification=a, and a combination weight in the case of the fault event combination sw3c is 40, which is the degree of importance of the event classification=c. A combination weight in the case of the fault event combination sw1a and sw3c is 50 (=(60+40)/2), which is an arithmetic mean value between the combination weight 60 for sw1a and the combination weight 40 for sw3c. Though the unique determination unit 102 adopts an arithmetic mean value as a method for calculating a combination weight for a pattern in which two events are combined here, the combination weight may be calculated by a maximum value, a minimum value, a harmonic mean value or the like.

After that, the unique determination unit 102 calculates, for each fault event combination, a registration rate for each of all the other fault IDs. In this case, the unique determination unit 102 may or may not calculate the registration rate for all the fault event combinations. That is, the unique determination unit 102 does not necessarily have to calculate a registration rate for a fault event combination. For example, the unique determination unit 102 sets a threshold for combination weights, and exclude a combination having a weight value below the threshold from registration rate calculation targets, that is, from unique pattern extraction targets. Thereby, it is possible to reduce the amount of calculation and shorten processing time. In the specific example at the lower part of FIG. 9, by setting the threshold to 50, the fault event combination sw3c with a combination weight of 40 is excluded.

Next, the unique determination unit 102 decides a largest registration rate among registration rates (there are a plurality of registration rates when there are a plurality of other fault IDs) for each fault event combination that have been calculated as above. In the specific example at the lower part of FIG. 9, since there is only one other fault ID, the calculated registration rate=the largest registration rate is obtained. That is, the largest registration rate of the fault event combination sw1a is 1.0, and the largest registration rate of the fault event combination sw1a and sw3c is 0.5.

Next, the unique determination unit 102 weights the determined largest registration rate by the combination weight to calculate a weighted largest registration rate. Here, though an indicator for the registration rate is “the smaller, the more unique”, an indicator for the degree of importance calculated based on an occurrence frequency is “the larger, the more important”, and the magnitude relationship is reversed. Therefore, the weighted largest registration rate can be calculated by a reciprocal of the largest registration rate×the combination weight (that is, the largest registration rate+the combination weight). In the specific example at the lower part of FIG. 9, the weighted largest registration rate of the fault event combination sw1a is 1.0+600.017, and the weighted largest registration rate of the fault event combination sw1a and sw3c is 0.5+50=0.010. This weighted largest registration rate calculation method is a mere example. In the case of calculating the degree of importance by a calculation method having the largest value, the weighted largest registration rate can be determined by other calculation methods such as multiplication of the largest registration rate by a value obtained by subtracting the combination weight from the largest value. Further, a weight may be added based on some other condition such as the number of events in a fault event combination.

Then, the unique determination unit 102 sorts weighted largest registration rates of all the fault event combinations and extracts a combination corresponding to the smallest value among these as a unique pattern. Therefore, since a weighted largest registration rate for combination that is the smallest is 25 in the specific example at the lower part of FIG. 9, a combination corresponding thereto is sw1a and sw3c, and the unique pattern for the fault ID=2 in the example of FIG. 9 is sw1a and sw3c.

Thus, in the present first embodiment, based on the degrees of importance of the fault events determined based on the occurrence situations of all the fault events registered with the fault example database 105, sw1a and sw3c, which are a fault event combination grasping characteristics of a fault, are extracted. In comparison, in the extraction procedure uniformly treating all fault events, as disclosed in Patent Literature 1, sw3c is extracted as a fault event combination.

According to the first embodiment explained above, it becomes possible to, by excluding such a fault event that occurred not being related to occurrence of a fault from candidates for being adopted for a rule while adopting a fault event that occurred in many fault examples for the rule, create a rule grasping characteristics of a fault more. That is, by weighting each fault event based on the occurrence situations of all fault events, it becomes possible to create an appropriate rule grasping characteristics of a fault more and prevent wrong detection or overdetection of a fault.

### Second Embodiment

Though degrees of importance of fault events are determined based on the occurrence situations of all the fault events as values calculated through analytical processing for overall information about fault events in the above first embodiment, the present second embodiment is such that the degrees of importance of fault events are determined based on rule creation results in the past. A degree of importance of a fault event in this case is a value obtained by quantifying whether the fault event resembles a fault event adopted for a past rule or not (whether a word included in a fault event adopted for the rule is included or not). The degree of importance of a fault event is calculated, for example, by extracting an important word that is likely to be adopted for a rule by Bayesian inference, and a definition is made so that a degree of importance of a fault event that includes such an important word is set high. Of course, the calculation method is not limited to the above.

Hereinafter, an explanation will be made on an example of a calculation method for determining degrees of importance of fault events by important words which are rule creation results in the past. Of course, the calculation method is not limited to this calculation method.

A fault event is defined as follows. Here, W indicates a set (a set without duplication) of all words included in a fault event group; L indicates a set of all fault events; and lᵢ indicates a word string included in each fault event. That is, lᵢ is a sentence consisting of nᵢ words. Here, each wᵢⱼ is an element of W. Pieces of content of words may be duplicated, and it is possible that a certain word appears a plurality of times.

W={w₁,w₂, . . . ,wₙ}

L={l₁,l₂, . . . ,lₙ}

lᵢ={wᵢ₁,wᵢ₂, . . . ,wᵢₙ_{ᵢ}} [Math. 2]

That is, a fault event refers to the set L of all the fault events and content thereof. Content of each fault event is a sequence of words obtained as a result of performing division into words (tokenization) and deletion of unnecessary parts (parts corresponding to a date and time and a number) for an original character string of the fault event. Order of the words is not necessary for processing but the number of appearances of each word is necessary. As the deletion of unnecessary parts, for example, a process of leaving words consisting only of alphabets (deleting words including a symbol or a numeral) is conceivable.

A fault event adopted for a rule is defined as follows.

R⊂L

R̅⊂L [Math. 3]

(Hereinafter “R” may be written as “R”)

Here, R indicates a set of fault events adopted for rules, and, in actual processing, elements are determined based on a result of creation of the rule. The set R of fault events adopted for rules is updated by adding a fault event sentence adopted as a condition when a rule is created or corrected, to the fault events adopted for rules. Further, R indicates a set of fault events that are not adopted for rules. That is, R and R are in the following relationship.

R̅∪R=L and R̅∩R=0 [Math. 4]

Further, the number of words is defined as follows. Here, F_{R}(w) indicates the number of times a certain word is included in fault events adopted for rules (the number of appearances), and F_{R}(w) indicates the number of times the certain word is included in fault events not adopted for rules (the number of appearances).

F_{R}(w):W→N

F_{R}(w):W→N

A probability is defined as below. Though the following is a definition for the set R of fault events adopted for rules, the set R of fault events not adopted for rules is similarly defined. Here, P(R) indicates a rate of the fault events adopted for rules, and P(w|R) indicates the probability (a rate) of the fault events adopted for rules including a word w.

$$[ Math . 5 ]$$

$$P ( R ) = \frac{‖ R ‖}{‖ L ‖} \\ P ( w \vert R ) = \frac{{F}_{R} ( w ) + 1}{{\sum }_{υ ∈ W} {F}_{R} ( υ ) + ‖ W ‖}$$

Here, the denominator of the right side of the expression of P(R) indicates the number of fault events, that is, the number of elements of the set L of all the fault events, and the numerator indicates the number of the fault events adopted for rules, that is, the number of elements of the set R of the fault events adopted for rules. Here, υ moves through all of words that can appear in the fault events adopted for rules (that is, the elements of R). Additions in the denominator and the numerator on the right side of the expression of P(w|R) are by Laplace method (additive smoothing).

A degree of importance of a fault event is calculated as below. Here, S(R|lᵢ) indicates an index of the probability of a fault event lᵢ being adopted for a rule, and S(R|lᵢ) indicates an index of the probability of the fault event lᵢ not being adopted for a rule. The way of thinking of Naive Bayes is adopted in the above. Originally, a co-occurrence relationship among words may not be independent. Nevertheless, it is assumed that the co-occurrence relationship is independent, and a posterior probability is calculated by calculating the probability of events occurring at the same time by simple multiplication and applying the Bayes' theorem.

S(R|lᵢ)=P(R)·ΠⱼP(wᵢⱼ|R)

S(R̅|lᵢ)=(1−P(R))·ΠⱼP(wᵢⱼ|R̅) [Math. 6]

For a certain fault event, the following value can be adopted as a degree of importance of the fault event.

$$[ Math . 7 ]$$

$$\frac{s ( R \vert l )}{s ( R \vert l ) + s ( \overline{R} \vert l )}$$

In the case of determining a degree of importance of a fault event based on rule creation results in the past as described above, the configuration of the pattern extraction and rule generation device 1 may be similar to the configuration in the first embodiment shown in FIG. 1. Operations of the unique determination unit 102 and the fault event importance degree determination unit 102A are different from those of the first embodiment.

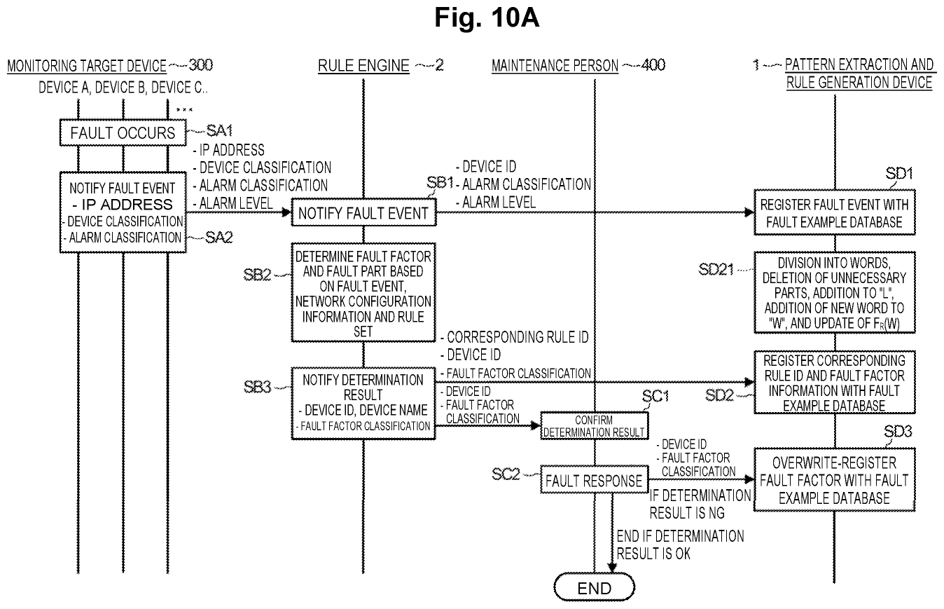

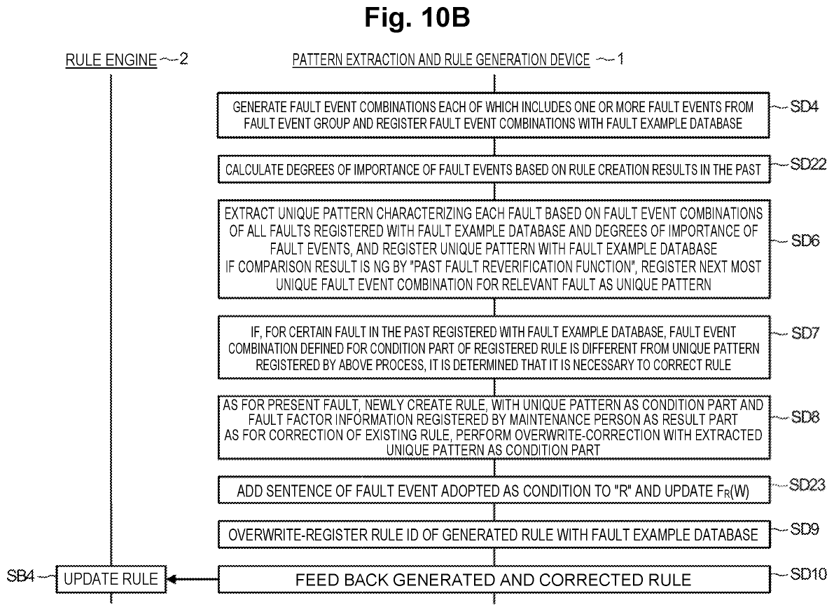

FIGS. 10A and 10B are flowcharts showing an example of processing operations in an abnormal part estimation system including a pattern extraction and rule generation device 1 as a rule generation device according to the present second embodiment, and the rule engine 2. Here, processes similar to the processing operations in the abnormal part estimation system in the first embodiment are given the same reference signs as FIGS. 6A and 6B, and explanation thereof will be omitted. As for the processing operations shown in FIG. 6C, illustration and explanation thereof will be omitted because they are similar in the present second embodiment.

In the pattern extraction and rule generation device 1 in the present second embodiment, when a fault event is registered with the fault example database 105 at step SD1, the fault event importance degree determination unit 102A of the unique determination unit 102 performs division into words and deletion of unnecessary parts for a character string of the fault event registered with the fault example database 105 and then adds and registers the fault event with the set L of all fault events registered with the fault example database 105. Further, if, among the divided words, there is a word that is still not registered with a set W of all words included in fault event groups registered with the fault example database 105, the fault event importance degree determination unit 102A adds and registers the word with the set W of all the words included in the fault event groups. Furthermore, the fault event importance degree determination unit 102A updates the number of times the certain word is included in the fault events not adopted for rules (the number of appearances) FR (w) which is registered with the fault example database 105 (step SD21).

Further, in the pattern extraction and rule generation device 1 of the present second embodiment, the fault event importance degree determination unit 102A included in the unique determination unit 102 determines degrees of importance of one or more fault events based on rule creation results in the past registered with the fault example database 105, for example, important words instead of step SD5 in the first embodiment (step SD22). Then, at step SD6, the unique determination unit 102 extracts a unique pattern based on the determined degrees of importance of the fault events.

Further, in the pattern extraction and rule generation device 1 in the present second embodiment, the fault event importance degree determination unit 102A of the unique determination unit 102 adds and registers a sentence of a fault event adopted as a condition when a rule is created or corrected at step SD8, with the set R of fault events adopted for rules, which is registered with the fault example database 105. Furthermore, the fault event importance degree determination unit 102A updates the number of times the certain word is included in fault events adopted for rules (the number of appearances) F_{R} (w) which is registered with the fault example database 105 (step SD23).

According to the second embodiment explained above, it becomes possible to, by extracting a word that tends to be likely to be adopted for a fault event, from past rules, create a rule that is regarded as important based on rule creation results in the past. That is, by weighting each fault event based on the rule creation results in the past, it becomes possible to create an appropriate rule grasping characteristics of a fault more and prevent wrong detection or overdetection of a fault.

### Third Embodiment

Next, a third embodiment will be explained. The present third embodiment is such that degrees of importance of fault events are determined based on fault factor parts, that is, location of devices in which the fault events occurred on a network, which are values calculated through analysis processing for information other than the fault events. A degree of importance of a fault event in this case is, for example, a value obtained by quantifying a position (a layer) of the occurrence part relative to a network topology. As a method for calculating the degree of importance of a fault event, for example, the degree of importance is defined so that the value is larger as the layer is upper or lower. Further, the degree of importance of a fault event may be a value obtained by quantifying a position of a failure part (a chassis, a card or a port) inside a node. As a method for calculating the degree of importance of a fault event in this case, for example, the degree of importance is defined so that the value is larger as the layer is upper or lower. For example, the degree of importance can be defined according to a resource classification. The location of devices in which fault events occurred on the network is, of course, not limited to a position in a network topology and a part inside a node.

In the case of determining degrees of importance of fault events based on location of devices in which the fault events occurred on the network as described above, the configuration of the pattern extraction and rule generation device 1 may be similar to the configuration in the first embodiment shown in FIG. 1. Operations of the unique determination unit 102 and the fault event importance degree determination unit 102A are different from those of the first embodiment.

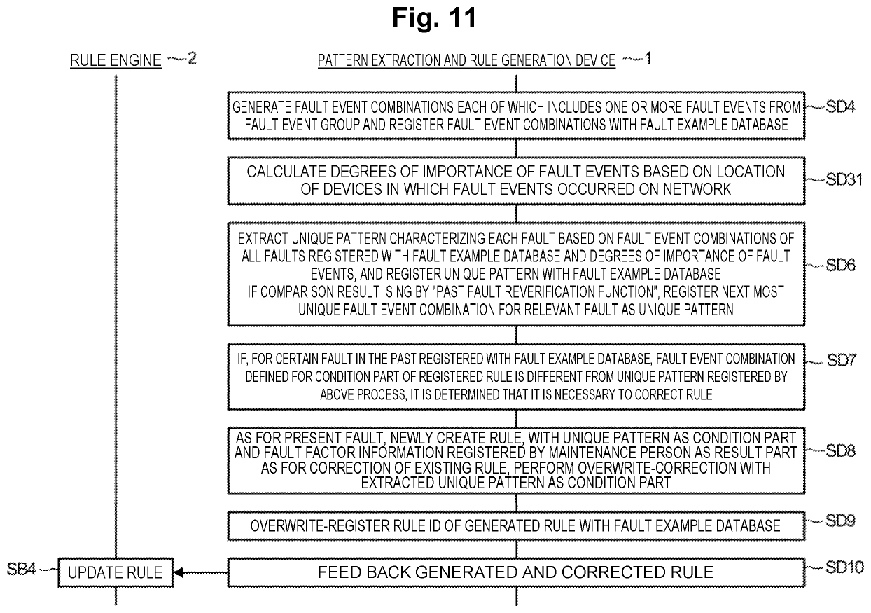

FIG. 11 is a flowchart showing an example of processing operations in an abnormal part estimation system including a pattern extraction and rule generation device 1 as a rule generation device according to the present third embodiment, and the rule engine 2. Here, processes similar to the processing operations in the abnormal part estimation system in the first embodiment are given the same reference signs as FIG. 6B, and explanation thereof will be omitted. As for the processing operations shown in FIGS. 6A and 6C, illustration and explanation thereof will be omitted because they are similar in the present third embodiment.

In the pattern extraction and rule generation device 1 in the present third embodiment, the fault event importance degree determination unit 102A of the unique determination unit 102 determines degrees of importance of one or more fault events based on location of devices in which the fault events occurred on the network, which are registered with the fault example database 105 instead of step SD5 in the first embodiment (step SD31). Then, at step SD6, the unique determination unit 102 extracts a unique pattern based on the determined degrees of importance of the fault events.

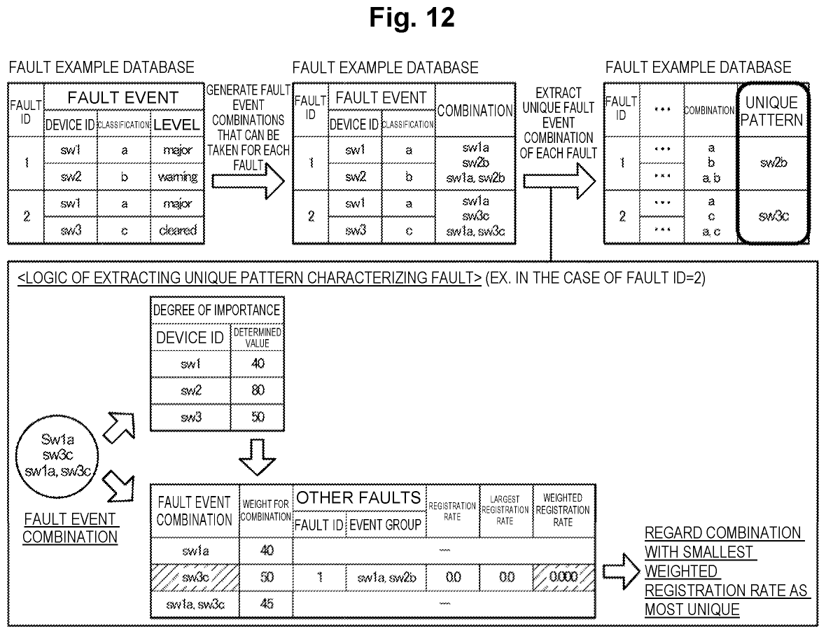

FIG. 12 is a diagram showing an example of a unique pattern extraction procedure at step SD6. Hereinafter, extraction of a unique pattern will be explained with reference to a specific example at a lower part of FIG. 12.

In the specific example at the lower part of FIG. 12, fault event combinations for a fault ID=2 are three combinations of sw1a, sw3c, and sw1a and sw3c similarly to the example of FIG. 9 in the first embodiment. Further, since there are only two fault IDs, 1 and 2 in this example, it is only ID=1 that is a fault other than ID=2. It is assumed that, as degrees of importance for individual device IDs, which are degrees of importance of fault events, 40, 80 and 50 have been determined for a device ID=sw1, a device ID=sw2 and a device ID=sw3, respectively, at step SD31 in this example. Therefore, in this example, a combination weight in the case of the fault event combination sw1a is 40, which is the degree of importance of the device ID=sw1, and a combination weight in the case of the fault event combination sw3c is 50, which is the degree of importance of the device ID=sw3. A combination weight in the case of the fault event combination sw1a and sw3c is 45 (=(40+50)/2), which is an arithmetic mean value between the combination weight 40 of sw1a and the combination weight 50 of sw3c. Though the unique determination unit 102 adopts an arithmetic mean value as a method for calculating a combination weight for a pattern in which two events are combined here, the combination weight may be calculated by a maximum value, a minimum value, a harmonic mean value or the like.

After that, the unique determination unit 102 calculates, for each fault event combination, a registration rate for each of all the other fault IDs. Here, by setting a threshold 50 for combination weights and excluding combinations having a weight value below the threshold similarly to the first embodiment, the fault event combination sw1a with the combination weight of 40 and the fault event combination sw1a and sw3c with the combination weight of 45 can be excluded.

Next, the unique determination unit 102 decides a largest registration rate among registration rates (there are a plurality of registration rates when there are a plurality of other fault IDs) for each fault event combination calculated as above. In the specific example at the lower part of FIG. 12, since there is only one other fault ID, the calculated registration rate=the largest registration rate is obtained. That is, the largest registration rate of the fault event combination sw3c is 0.0.

Next, the unique determination unit 102 weights the determined largest registration rate by the combination weight to calculate a weighted largest registration rate. The weighted largest registration rate can be calculated by a reciprocal of the largest registration rate×the combination weight (that is, the largest registration rate+the combination weight). In the specific example at the lower part of FIG. 12, the weighted largest registration rate of the fault event combination sw3c is 0.0÷50=0.000. This weighted largest registration rate calculation method is a mere example, and a weight may be added based on some other condition such as the number of events in a fault event combination.

Then, the unique determination unit 102 sorts weighted largest registration rates of all the fault event combinations and extracts a combination corresponding to the smallest value among these as a unique pattern. Therefore, in the specific example at the lower part of FIG. 12, a combination with a weighted largest registration rate for combination that is the smallest is sw3c, which is a combination with a weighted largest registration rate of 0, and the unique pattern for the fault ID=2 in the example of FIG. 12 is sw3c.

Thus, in the present third embodiment, based on the degrees of importance of fault events determined based on location of devices in which the fault events occurred on the network, sw3c, which is a fault event combination grasping characteristics of a fault, is extracted.

According to the third embodiment explained above, it is possible to, by regarding a fault event of a device on an upper layer assumed to be influential on a network as important, preferentially adopt a more influential fault event for a rule. Or alternatively, it is possible to, by regarding a fault event at a part on a device, which is assumed to be influential, as important, preferentially adopt a more influential fault event for a rule. Therefore, by weighting each of fault events based on location of devices in which the fault events occurred on a network, it becomes possible to create an appropriate rule grasping characteristics of a fault more and prevent wrong detection or overdetection of a fault.

### Fourth Embodiment

Degrees of importance of fault events are determined based on occurrence situations of all fault events, rule creation results in the past and location of devices in which fault events occurred on a network in the first embodiment, the second embodiment and the third embodiment, respectively. These determination criteria may be combined. That is, the occurrence situations of all fault events in the first embodiment and the rule creation results in the past in the second embodiment may be combined; the occurrence situations of all fault events in the first embodiment and the location of devices in which fault events occurred on a network in the third embodiment may be combined; or the rule creation results in the past in the second embodiment and the location of devices in which fault events occurred on a network in the third embodiment may be combined. Furthermore, the three of the occurrence situations of all fault events in the first embodiment, the rule creation results in the past in the second embodiment and the location of devices in which fault events occurred on a network in the third embodiment may be combined.

Hereinafter, as an example, the combination of the occurrence situations of all fault events in the first embodiment and the location of devices in which fault events occurred on a network in the third embodiment will be explained as a fourth embodiment.

In this case, the configuration of the pattern extraction and rule generation device 1 may be similar to the configuration in the first embodiment shown in FIG. 1. Operations of the unique determination unit 102 and the fault event importance degree determination unit 102A are different from those of the first embodiment.

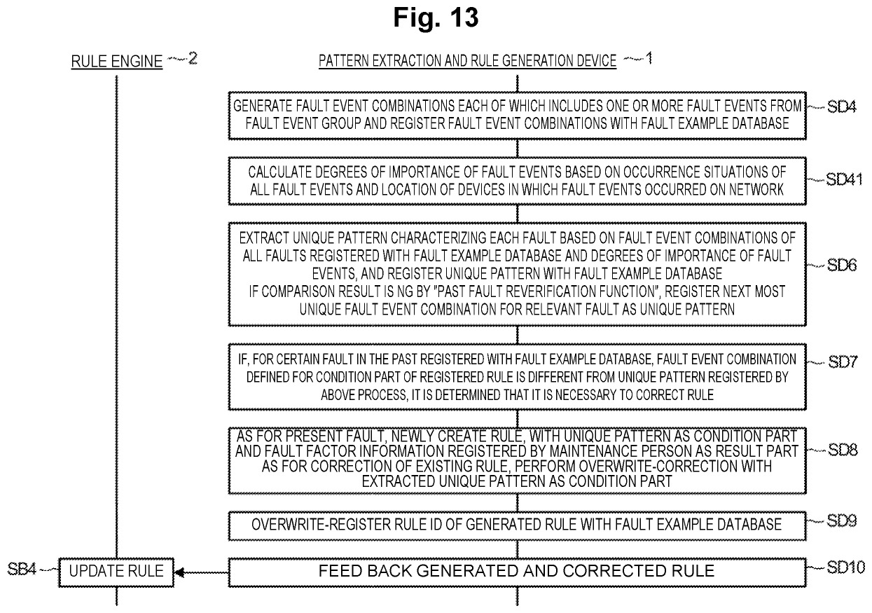

FIG. 13 is a flowchart showing an example of processing operations in an abnormal part estimation system including a pattern extraction and rule generation device 1 as a rule generation device according to the present fourth embodiment, and the rule engine 2. Here, processes similar to the processing operations in the abnormal part estimation system in the first embodiment are given the same reference signs as FIG. 6B, and explanation thereof will be omitted. As for the processing operations shown in FIGS. 6A and 6C, illustration and explanation thereof will be omitted because they are similar in the present fourth embodiment.

In the pattern extraction and rule generation device 1 in the present fourth embodiment, the fault event importance degree determination unit 102A of the unique determination unit 102 determines degrees of importance of one or more fault events based on the occurrence situations of all the fault events and the location of devices in which fault events occurred on a network, which are registered with the fault example database 105, instead of step SD5 in the first embodiment (step SD41). Then, at step SD6, the unique determination unit 102 extracts a unique pattern based on the determined degrees of importance of the fault events.

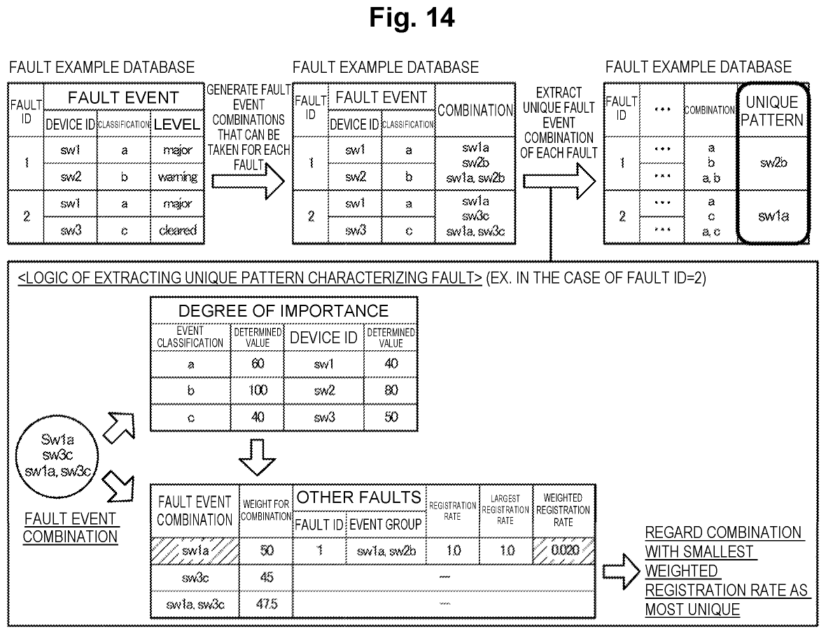

FIG. 14 is a diagram showing an example of a unique pattern extraction procedure at step SD6. Hereinafter, extraction of a unique pattern will be explained with reference to a specific example at a lower part of FIG. 14.

In the specific example at the lower part of FIG. 14, fault event combinations for a fault ID=2 are three combinations of sw1a, sw3c, and sw1a and sw3c similarly to the example of FIG. 9 in the first embodiment. Further, since there are only two fault IDs, 1 and 2 in this example, it is only ID=1 that is a fault other than ID=2. It is assumed that, as degrees of importance for individual event classifications, which are degrees of importance of fault events, 60, 100 and 40 have been determined for an event classification=a, an event classification=b and an event classification=c, respectively, and, as degrees of importance for individual device IDs, which are degrees of importance of fault events, 40, 80 and 50 are determined for a device ID=sw1, a device ID=sw2 and a device ID=sw3, respectively, at step SD41 in this example.

Therefore, in this example, a combination weight in the case of the fault event combination sw1a is 50 (=(60+40)/2), which is an arithmetic mean value between 60 which is the degree of importance of the event classification=a and 40 which is the degree of importance of the device ID=sw1. Though an arithmetic mean value is adopted as a combination weight calculation method here, a weighted mean value may be obtained by weighting one of the values. Further, the combination weight may be calculated by a maximum value, a minimum value, a harmonic mean value or the like. Similarly, a combination weight in the case of the fault event combination sw3c is 45 (=(40+50)/2), which is an arithmetic mean value between 40 which is the degree of importance of the event classification=c and 50 which is the degree of importance of the device ID=sw3. A combination weight in the case of the fault event combination sw1a and sw3c is 47.5 (=(50+45)/2), which is an arithmetic mean value between the combination weight 50 of sw1a and the combination weight 45 of sw3c. Though the unique determination unit 102 adopts an arithmetic mean value as a method for calculating a combination weight for a pattern in which two events are combined here, the combination weight may be calculated by a maximum value, a minimum value, a harmonic mean value or the like.

After that, the unique determination unit 102 calculates, for each fault event combination, a registration rate for each of all the other fault IDs. Here, by setting a threshold 50 for combination weights and excluding combinations having a weight value below the threshold similarly to the first embodiment, the fault event combination sw3c with the combination weight of 45 and the fault event combination sw1a and sw3c with the combination weight of 47.5 can be excluded.

Next, the unique determination unit 102 decides a largest registration rate among registration rates (there are a plurality of registration rates when there are a plurality of other fault IDs) for each fault event combination calculated as above. In the specific example at the lower part of FIG. 14, since there is only one other fault ID, the calculated registration rate=the largest registration rate is obtained. That is, the largest registration rate of the fault event combination sw1a is 1.0.

Next, the unique determination unit 102 weights the determined largest registration rate by the combination weight to calculate a weighted largest registration rate. The weighted largest registration rate can be calculated by a reciprocal of the largest registration rate×the combination weight (that is, the largest registration rate+the combination weight). In the specific example at the lower part of FIG. 14, the weighted largest registration rate of the fault event combination sw1a is 1.0÷50=0.020. This weighted largest registration rate calculation method is a mere example, and a weight may be added based on some other condition such as the number of events in a fault event combination.

Then, the unique determination unit 102 sorts weighted largest registration rates of all the fault event combinations and extracts a combination corresponding to the smallest value among these as a unique pattern. Therefore, since a weighted largest registration rate for combination that is the smallest is 50 in the specific example at the lower part of FIG. 14, the combination corresponding thereto is sw1a, and the unique pattern for the fault ID=2 in the example of FIG. 14 is sw1a.

Thus, in the present fourth embodiment, sw1a, which is a fault event combination grasping characteristics of a fault, is extracted based on degrees of importance of fault events determined based on occurrence situations of all the fault events and location of devices in which fault events occurred on a network.

According to the fourth embodiment explained above, by weighting each fault event based on degrees of importance of fault events determined based on a plurality of criteria, it becomes possible to create an appropriate rule grasping characteristics of a fault more and prevent wrong detection or overdetection of a fault.

### Other Embodiments

Though the pattern extraction and rule generation device 1 and the rule engine 2 are configured with separate computers in the above embodiments, they may be configured with one computer.

Further, the method described in each embodiment can be distributed by storing the method in a recording medium, for example, in a magnetic disk (a floppy (registered trademark) disk, a hard disk or the like), an optical disk (a CD-ROM, a DVD, an MO or the like), a semiconductor memory (a ROM, a RAM, a flash memory or the like) or the like or transmitting the method by a communication medium, as a program (software means) that can be executed by a calculator (a computer). The program stored in the medium side also includes a setting program for causing the software means (including not only an execution program but also tables and data structures) to be executed by the calculator to be configured in the calculator. The calculator that realizes the present device reads the program recorded in a recording medium or, in some cases, constructs the software means by the setting program, and executes the processes described above by its operation being controlled by the software means. The recording medium stated in the present specification is not limited to a recording medium for distribution but includes a storage medium such as a magnetic disk or a semiconductor memory provided inside the calculator or in an apparatus connected via a network.

In short, this invention is not limited to the above embodiments but can be variously modified within a range not departing from the spirit at the stage of implementation. Further, each embodiment may be appropriately combined and implemented as far as possible, and, in that case, combined effects can be obtained. Furthermore, the embodiments described above include inventions at various stages, and various inventions can be extracted by an appropriate combination of a plurality of disclosed constituent features.

### REFERENCE SIGNS LIST

1 Pattern extraction and rule generation device
2 Rule engine
11,21 Processor
12,22 Program memory
13,23 Data memory
14,24 Communication interface
15,25 Input/output interface
16,26 Bus
17,27 Input unit
18,28 Display unit
101 Fault event registration unit
102 Unique determination unit
102A Fault event importance degree determination unit
103 Rule generation and correction unit
104 Past fault reverification unit
105 Fault example database
201 Fault event transmission/reception unit
202 Network configuration information database
203 Determination logic unit
300 Monitoring target device
400 Maintenance person

1. A rule generation device comprising:
a database in which, for each fault, fault factor information including a fault factor part and a fault factor, fault events that occur due to this fault, a rule ID associated with a rule including a condition part and a result part are registered in association with one another;
a processor; and
a storage medium having computer program instructions stored thereon, when executed by the processor, perform to:
determining, when fault events of a new fault that is a newly occurred fault are registered with the database, degrees of importance of the fault events of the new fault based on at least one of values calculated through statistical processing or analytical processing for information other than the fault events or overall information about the fault events, which are registered with the database; and
generating a rule for the new fault based on the degrees of importance.

2. The rule generation device according to claim 1, wherein the computer program instructions further perform to determines degrees of importance of fault events of past faults that are faults in the past registered with the database; and
the rule generation unit comprises:
a unique determination unit generating all combinations of the fault events of the new fault and extracting, for each of the faults, a unique pattern that is determined to be a combination that occurs least frequently, from among the combinations of the fault events of the new fault and combinations of the fault events of the past faults that are the faults in the past, based on the degrees of importance of the fault events of the new fault and the past faults; and
a rule generation and correction unit generating the rule for the new fault according to the unique pattern corresponding to each of the faults and correcting the rules for the past faults.

3. The rule generation device according to claim 2, wherein, if the unique pattern correspondingly to any of the past faults registered with the database is different from a fault event combination defined for a condition part of a rule corresponding to this past fault, the computer program instructions further perform to corrects the rule by overwriting the condition part of this rule with the unique pattern.

4. The rule generation device according to claim 1, wherein the computer program instructions further perform to calculates the degrees of importance based on rule creation results in the past which are values calculated through the analytical processing for the overall information about the fault events.

5. The rule generation device according to claim 1, wherein the computer program instructions further perform to calculates the degrees of importance based on occurrence situations of all the fault events, which are values calculated through the statistical processing for the overall information about the fault events.

6. The rule generation device according to claim 1, wherein the computer program instructions further perform to calculates the degrees of importance based on location of devices in which the fault events occurred on a network, which are values calculated through the analytical processing for the information other than the fault events.

7. A rule generation method comprising:
registering, for each fault, fault factor information including a fault factor part and a fault factor, fault events that occur due to this fault, a rule ID associated with a rule including a condition part and a result part with a database in association with one another;
determining, when fault events of a new fault that is a newly occurred fault are registered with the database, degrees of importance of the fault events of the new fault based on at least one of values calculated through statistical processing or analytical processing for information other than the fault events or overall information about the fault events, which are registered with the database; and
generating a rule for the new fault based on the degrees of importance.

8. A non-transitory computer-readable medium having computer-executable instructions that, upon execution of the instructions by a processor of a computer, cause the computer to function as the rule generation device according to claim 1.
